(19) United States
(12) Patent Application Publication
(10) Pub. No.: US 2022/0344885 A1
(43) Pub. Date: Oct. 27, 2022

(54) ELECTRICAL CONTACT AND METHOD OF MANUFACTURING

(71) Applicant: HARWIN PLC, Portsmouth Hampshire (GB)

(72) Inventors: Scott FLOWER, Portsmouth Hampshire (GB); Mark PLESTED, Portsmouth Hampshire (GB); Andrew McQuilken, Portsmouth Hampshire (GB)

(21) Appl. No.: 17/760,837

(22) PCT Filed: Sep. 17, 2020
(86) PCT No.: PCT/GB2020/052239

§ 371 Date: Mar. 16, 2022

(30) Foreign Application Priority Data
Sep. 18, 2019 (GB) 1913477.4

(51) Int. Cl. H01R 43/16; H01R 13/11

(52) U.S. Cl. CPC H01R 43/16; H01R 13/111

(57) ABSTRACT

A socket contact and a method of making a socket contact is provided. The socket contact may comprise: a tubular body having: a first end; a second end opposite the first end, the body having an opening at the first and/or second end; and a plurality of slots forming a plurality of beam members, wherein at least one of the beam members comprises at least a first section that is inwardly raised relative to the remaining section of the beam members so as to form a narrower contact section within the socket contact. A first collar is proximal the first end and/or a second collar is proximal the second end. A sidewall portion extends between first collar portion and the second collar portion, wherein the sidewall portion comprises the plurality of slots forming the plurality of beam members, wherein each end of the beam member is fixed and anchored in the sidewall portion adjacent each collar such that in use when a mating pin enters the socket contact, the beam members are pressed outwards and the contact section remains substantially concentric about a central longitudinal axis of the socket contact.

The present invention relates to electrical contacts, and more particularly electrical socket contacts that may be used for interconnection and may receive electrically conductive members such as an electrical wire or an electrical mating pin.

An electrical socket contact can be used to receive an electrically conductive member such as an electrical wire or electrical pin. The socket contact retains the conductive member and can make an electrical connection with the electrically conductive member. One type of electrical socket contact is a hyperboloid socket contact that has a tail portion and an opening at the opposite end to receive a pin. A plurality of conductive bands are located between the tail portion and the opposite end and the bands are arranged in a hyperboloid shape. A pin can be received in the opening in the opposite end. The pin may have a singular point of contact per band.

The inventors have found that there is a need for a versatile contact that has reduced wear and increased mating cycle, is highly reliably in severe environments, and manufacturable on a miniature scale.

From a first aspect, the present invention provides a socket contact comprising: a tubular body/barrel having: a first end; a second end opposite the first end, the body having an opening at the first and/or second end; a plurality of slots forming a plurality of beam members, wherein at least one of the beam members comprises at least a first section that is inwardly raised relative to remaining section of the beam members so as to form a narrower contact section within the socket contact.

Each of the beam members may comprises the first inwardly raised section.

The socket contact may further comprise: a first collar proximal the first end; and/or a second collar proximal the second end; a sidewall portion extending between first collar portion and the second collar portion, wherein the sidewall portion comprises the plurality of slots forming the plurality of beam members.

A diameter of an outer surface of each collar may be larger than diameter of outer surface of the sidewall portion to allow for expansion of the beam members upon contact of the contact section of each beam member. Each end of the beam member is fixed and therefore anchored in the sidewall portion adjacent the collar. When a mating pin enters the socket contact, the beam members are pressed outwards but the contact section remains concentric about a central longitudinal axis of the socket contact and moves such that the faces of the contact section stay substantially parallel to the mating pin. The overall length of the socket contact may shorten to accommodate the sidewall portion expanding outwards on a microscopic scale. The beams being attached at both ends can also prevent potential damage from misalignment and handling of contact socket.

Each collar may extend entirely or partially around a circumference of the tubular body.

The socket contact may comprise at least three slots and the slots may be generally extending in a direction along and parallel to a central longitudinal axis of the tubular body. Each of the slots may be aligned adjacent each other around the periphery of the tubular body.

The slots may be angled such that their longitudinal axis is at an angle to the central longitudinal axis of the tubular body. Each slot may start at one side of the central axis, crossing it and finishing on the opposite side of the central axis. By creating offset angled slots, the inwardly raised contact section provides a ridge that can include perpendicular edges to the contact's central longitudinal axis and two angled edges based on the angled edges of the corresponding base member which can provide four points of contact per beam member.

From a second aspect, the present invention provides a method of manufacturing a socket contact, comprising: providing a tubular body having a first end and a second end opposite the first end; forming a hole through the body along a central longitudinal axis of the body and an opening at the first and/or second end, wherein the hole comprises a portion with at least a first cross section and a portion with at least a second cross section, wherein the first cross section is larger than the second cross section; forming a plurality of slots to create a plurality of beam members, wherein at least one of the beam members comprises at least a first section that is inwardly raised relative to remaining section of the beam members so as to form a narrower section within the socket contact. The forming of the hole through the body may include forming a through hole having the second cross section before forming a through hole having the second cross section.

The method may further comprise adapting the surface of the contact to form a first collar proximal the first end and a second collar proximal the second end, where a sidewall portion extends between first collar and the second collar and the slots are formed in the sidewall portion. The adapting may be forming a recess in the surface of the tubular body to form the first and second collar. The surface of the collars can be used to retain the socket contact in an insulator housing and can prevent movement of the socket contact within the insulator housing. Further fixing elements or means may be provided to secure the socket contact in place in the housing.

The socket contact is generally hollow and, holes can be formed internally within the body of the contact with different cross sections along the central longitudinal axis to create a barrel structure, the barrel structure including a first hollow portion of a first diameter, second hollow portion of a second diameter and third hollow portion of a third diameter. The second hollow portion is positioned coaxially between the first and third hollow portions, wherein the second diameter is smaller than the first diameter, and the third diameter may be the same as the first diameter. The contact section may be formed in the second hollow portion and can be formed before the slots are created. The structure can thus be symmetrical and allows a wire or mating pin to be crimped in either end of the socket contact thus giving two options when assembling the contact to the corresponding part which speeds up the assembly process and production.

The socket contact can be formed from a single piece of material.

Each end of the inwardly raised contact section may have a sloped lead-in face that can enable a smooth movement of a mating pin into the contact section.

A section of the body of the socket contact between the first end and collar portion proximal the first end may be provided with one or more indentations around the periphery of the section so as to provide a crimping section having a barrel crimp. A section of the body of the socket contact between the second end and collar portion proximal the second end may also or alternatively be provided with one or more indentations around the periphery of the section so as to provide a crimping section having a barrel crimp. Such a barrel crimp can provide a highly reliable, gas-tight joint. In one example, there may be four indentations and, in another example, there may be eight indentations.

In order that the invention may be more readily understood, reference will now be made, by way of example only, to the accompanying drawings, in which:

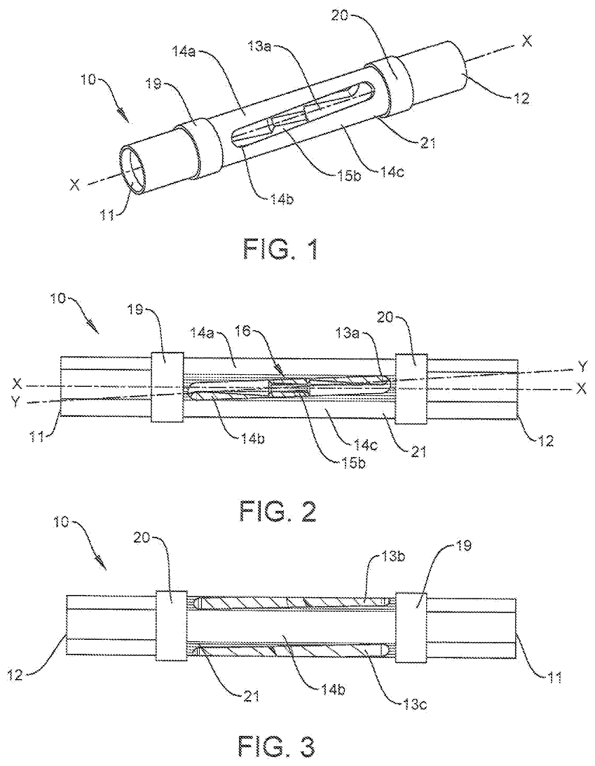

FIG. 1 is a perspective view of a socket contact according to an embodiment of the present invention;

FIG. 2 is a view of the contact of FIG. 1 from one side;

FIG. 3 is a view of the contact of FIG. 2 from an opposite side;

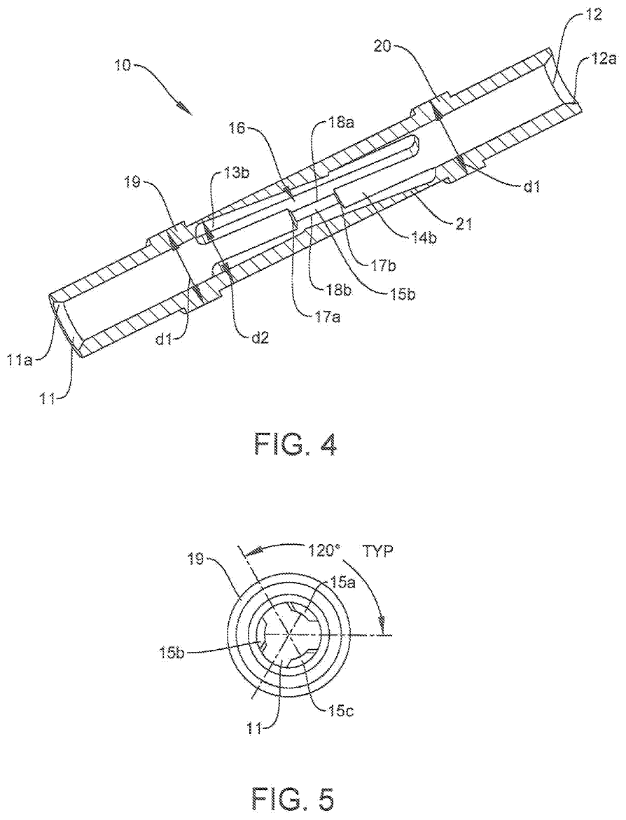

FIG. 4 is a cross sectional view of the contact of FIG. 1 with the cross section taken along a central longitudinal axis of the connector of FIG. 1;

FIG. 5 is an end view of the contact of FIG. 2 taken from the first end of the contact;

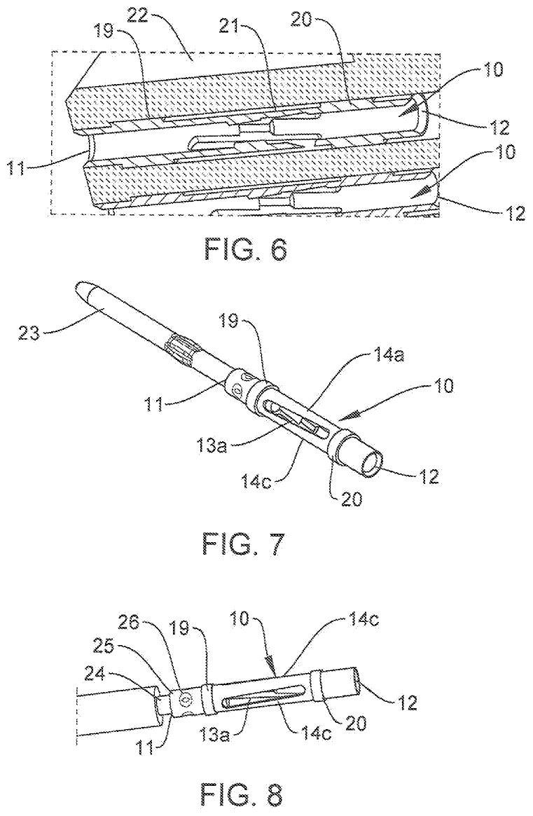

FIG. 6 is a partial cross sectional view of a two socket contacts of FIG. 1 in an example insulator housing;

FIG. 7 is a perspective view of a mating pin engaged with the socket contact;

FIG. 8 is a perspective view of an electrical wire connected to the socket contact;

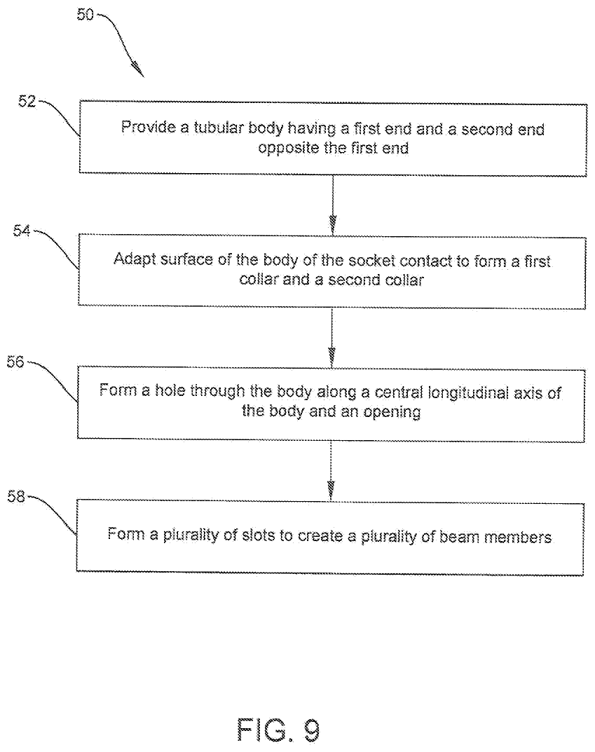

FIG. 9 is a block diagram of an example manufacturing process of a socket contact of FIG. 1.

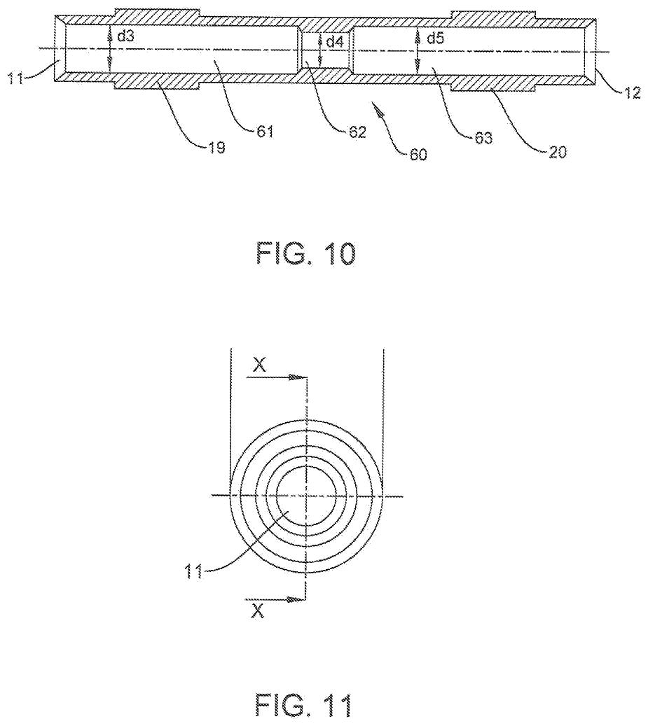

FIG. 10 is a cross sectional view taken along the longitudinal axis of a partially formed contact before slots are applied in the body of the contact to form the contact of FIG. 1.

FIG. 11 is an end view perspective view of the partially formed contact of FIG. 10;

Referring to FIGS. 1 to 5, there is shown a female electrical connector which is a socket contact 10 according to an embodiment. The socket contact comprises a tubular body which is in the form of a cylindrical hollow barrel having a first end and a second end opposite the first end. The body has an opening 11 at the first end an opening 12 at the second end—thus the barrel can be an open-ended hollow cylinder. In alternative configurations, only one of the ends may have an opening. Each end of the socket contact 10 at each opening 11, 12 may have a sloped lead-in area 11a, 12a.

A plurality of slots 13a, 13b, 13c are formed in the body of the socket contact 10. The slots 13a, 13b, 13c generally extend in a direction parallel to a central longitudinal axis X-X of the tubular body. Each of the slots 13a, 13b, 13c may be circumferentially aligned adjacent each other around the periphery of the tubular body. The slots 13a, 13b, 13c may be angled such that their longitudinal axis Y-Y is at an angle to the central longitudinal axis X-X of the tubular body. Each slot 13a, 13b, 13c may start at one side of the central axis X-X, crossing it and finishing on the opposite side of the central axis X-X. In this embodiment, three slots are formed in the body and are equally circumferentially spaced apart by 120 degrees (see FIG. 5) but it will be appreciated that a different number may be provided and the spacing can be changed accordingly.

The slots 13a, 13b, 13c form a plurality of corresponding beam members 14a, 14b, 14c in the body, and the beam members 14a, 14b, 14c comprise at least a first section 15a, 15b, 15c that is inwardly raised relative to remaining section of the beam members 14a, 14b, 14c so as to form a narrower contact section 16 within the socket contact 10. Each inwardly raised first section 15a, 15b, 15c is in the form of a ridge having a face that includes perpendicular edges 17a, 17b to the contact's central longitudinal axis X-X and two angled edges 18a,18b based on the angled edges of the corresponding beam member 14a, 14b, 14c which can provide four points of contact per beam member 14a, 14b, 14c for a mating pin, for example, that may be received by the socket contact 10 and, therefore, twelve points of contact per socket contact 10 may be provided. In other embodiments, if there are more beams, additional points of contact can be added per beam and with the inwardly raised ridge as explained above, there will be four additional points per beam.

The socket contact 10 further comprises a first collar 19 proximal the first end of the socket contact, adjacent the opening 11 and may further comprise a second collar 20 proximal the second end, and adjacent the opening 12. Each collar 19, 20 extends entirely around a circumference of the tubular body. It will be appreciated that in other embodiments, there may be only one collar and/or the collar may extend only partially around the circumference of the tubular body. The

A sidewall portion 21 extends between first collar 19 and the second collar 20, and the sidewall portion 21 comprises the plurality of slots 13a, 13b, 13c that form the plurality of corresponding beam members 14a, 14b, 14c.

A diameter d1 of an outer surface of each collar 19, 20 may be larger than a diameter d2 of outer surface of the sidewall portion 21 to allow for expansion of the beam members 14a, 14b, 14c upon contact of the contact section 16a, 16b, 16c of each beam member 14a, 14b, 14c. Each end of the beam member 14a, 14b, 14c is fixed and therefore anchored at the sidewall portion 21 adjacent the respective collars 19, 20.

As shown in FIG. 6, the socket contact 10 may be received in an insulator housing 22 such that an opening at one end of the socket contact 10 is aligned with an opening in the insulator housing 22. The angular orientation about the axis of the socket contact 10 within a hole in the insulator housing 22 is not critical given the configuration of the socket contact 10 such that the socket contact 10 may be inserted into the hole of the insulator housing 22 at any angular configuration relative to the axis of the hole. The one end of the socket contact 10 may receive a conductive member such as mating pin through the opening at the one end. The collars 19, 20 can be used as retention members to retain the socket contact 10 in an insulator housing 22 and can prevent movement of the socket contact 10 within the insulator housing 22 when a mating pin (not shown in FIG. 6) is inserted. Further fixing elements or means may be provided to secure the socket contact 10 in place in the housing 22. For example, one end such as the second end of the socket contact 10 which is entirely contained within the housing 22 in the configuration in FIG. 6 may be secured by a mechanical fixing element or means (not shown) in the housing 22 or potted using a potting material such as thermoplastic to bond the socket contact 10 to the housing 22. The collars 19,20 can also be used a guide members to suitably position the socket contact 10 in an insulator housing where, for example, the socket contact 10 may need to be centrally positioned within the housing.

With some or all of the features described above, the socket contact 10 has a symmetrical design such that a wire or mating pin can be crimped in either end of the socket contact 10 thus providing versatility in the use of the socket contact and speeds up the assembly process and production when assembling the socket contact 10 to a corresponding part. Furthermore, when crimped on to a mating pin the contact socket 10 provides the manufacturer with the option of having a different plating finish on a crimped pin such as tin-lead, tin, silver and then another finish on the socket contact 10 such as gold. This is particularly advantageous the socket contact 10 that may be manufactured using at least a turning machining process from a single piece of material and then barrel plated. The open design with slots can improve the barrel plating process by reducing the likelihood of air becoming trapped and masking the contact surfaces from the plating material used to plate the socket contact 10 such as gold.

As shown in FIG. 7, the socket contact 10 may receive a mating pin 23. The mating pin may be used as a printed circuit board interconnect but other types of mating pins can be used with the socket contact 10. The mating pin 23 enters the socket contact 10, and the beam members 14a, 14b, 14c move outwards in a transverse direction to the central longitudinal axis X-X but the contact section 16a, 16b, 16c remains concentric about the central longitudinal axis X-X and moves such that the face of each contact section 16a, 16b, 16c that is defined by the perpendicular edges 17a, 17b and two angled edges 18a,18b stays substantially parallel to the mating pin. Also, given the constraining of the beam members 14a, 14b, 14c at either end, the surface of the end portion of the body of the socket contact 10 between the first end and collar 19 proximal the first end, the surface of the end portion of the body of the socket contact 10 between the second end and collar 20 proximal the second end, and the mating surface of the contact portion 16 remain substantially parallel throughout movement of the mating pin 23 but the axis of the mating surface of the contact portion 16 and the end portions is no longer collinear. The overall length of the socket contact 10 may shorten to accommodate the sidewall portion 21 expanding outwards on a microscopic scale. The beam members 14a, 14b, 14c being attached at both ends can also prevent potential damage from misalignment and handling of contact socket 10 whilst providing spring-like properties when a mating pin is inserted into the socket contact 10.

As shown in FIG. 8, the socket contact 10 may receive a wire 24 at one end and crimped to the wire to provide a wire interconnect. An end portion 25 of the body of the socket contact 10 between the first end and collar 19 proximal the first end may be provided with one or more indentations 26 around the periphery of the end portion 25 so as to provide a crimping section having a barrel crimp. The opposite end portion of the body of the socket contact between the second end and collar 20 proximal the second end may also or alternatively be provided with one or more indentations (not shown) around the periphery of the section so as to provide a crimping section having a barrel crimp. Such a concentric barrel crimp area can provide a gas tight joint when crimped to a wire or mating pin and can prevent corrosion and oxidation in this area of the socket contact 10. In one example, there may be four indentations and, in another example, there may be eight indentations.

An example method of manufacturing a socket contact 10 such as that described above will now be described with reference to FIGS. 9 to 11. Reference will also be made to previously-described features shown in the previous figures and like reference numerals will be used where appropriate.

Referring firstly to FIG. 9, a method of manufacturing a socket contact 10 comprises providing 52 a single piece of material in the form of a solid tubular body having a first end and a second end opposite the first end. The single piece may be of beryllium copper but other similar materials may be used. The tubular body may be formed or turned using a lathe or turning machine which will be known to those skilled in the art. At 54, a surface of the body of the socket contact is adapted by creating recesses in the surface to form a first collar proximal the first end and a second collar proximal the second end, where a sidewall portion extends between first collar and the second collar. As mentioned in relation to FIG. 6, the surface of the collars can be used to retain the socket contact in an insulator housing and can prevent movement of the socket contact within the insulator housing. The method further comprises forming 56 a hole through the body along a central longitudinal axis of the body and an opening at the first and/or second end. The forming includes forming a hole with a first cross section and a hole with a second cross section, wherein the diameter of the first cross section is larger than the second cross section. The holes may be formed by a drilling process or other machining process. At 58, a plurality of slots are formed to create a plurality of beam members. The slot may be formed by a milling process or other similar machining process. In one example, a 0.20 mm end mill may be used which can ensure little or no swarf remains in the slot. At least one or all of the beam members comprise at least a first section that is inwardly raised relative to remaining section of the beam members so as to form a narrower contact section within the socket contact 10. The first section is inwardly raised in that the wall of the body of the socket contact at the first section is thicker than the remaining section of the socket contact 10. It will be appreciated that in this manner a ridge can be conveniently formed from the material of the socket contact 10 rather than being a discrete part attached separately. It will also be appreciated that the method can be performed in a different order to create the socket contact 10.

Referring to FIGS. 10 and 11, the holes formed at 56 of FIG. 9 can have different cross sections along the central longitudinal axis to create a barrel structure 60 after the surface recesses and the collars 19, 20 have been formed at 54. The barrel structure includes a first hollow portion 61 of a first diameter d3 having the opening 11 at a one end, second hollow portion 62 of a second diameter d4 and third hollow portion 63 of a third diameter d5 having the opening 12 at one end. The second hollow portion 62 is positioned axially between the first and third hollow portions 61, 63, wherein the second diameter d4 is smaller than the first diameter d3, and the third diameter d5 is the same as the first diameter d3. The socket contact 10 is therefore generally hollow and the contact section formed at 58 in FIG. 9 is formed in the second hollow portion and can be formed before the slots are created. The structure can thus be symmetrical and allows a wire or mating pin to be crimped in either end of the socket contact. At the intersection between the first hollow portion 61 and the second hollow portion 62 there is a sloped lead-in face 64. Similarly, at the intersection between the third hollow portion 63 and the second hollow portion 62 there is a sloped lead-in face 65. Therefore, each side of the inwardly raised contact section has a sloped lead-in face 64, 65 that can enable a smooth movement of a mating pin into the contact section. This can be caused by forming a hole of larger cross section (matching the cross section of each of the first hollow portion 61 and third hollow portion 63) from each end of the solid tubular body at 54 of FIG. 9 after a hole representing the cross section of the second narrower hollow portion 62 has been created.

The formed socket can be a micro-miniature part and in terms of the extent to which it can be manufactured to a micro-miniature scale, in some examples, the socket contact is around 4.5 mm in length and 0.7 mm in diameter at its largest point. The contact may be designed to accept a 0.3-0.4 mm mating pin. It will be appreciated, however, that the socket contact can be scaled to be used with smaller or larger connector systems as appropriate. Given that the socket contact 10 is manufactured from a single piece of solid material that has a continuous circumferential surface rather than a C-shaped cross section having a non-continuous circumferential surface which may have been manufactured by rolling a flat material, the socket contact 10 can maintain a consistent insertion and withdrawal force when operating.

In addition to the embodiments of the invention described in detail above, the skilled person will recognize that various features described herein can be modified and/or combined with additional features, and the resulting additional embodiments of the invention are also within the scope of the accompanying claims.

In addition, the following is a list of additional embodiments, which may serve as the basis for additional claims in this application or subsequent divisional applications.

Embodiment 1. A socket contact comprising:
a tubular body having:
   a first end;
   a second end opposite the first end, the body having an opening at the first and/or second end;
   a plurality of slots forming a plurality of beam members,
wherein at least one of the beam members comprises at least a first section that is inwardly raised relative to the remaining section of the beam members so as to form a narrower contact section within the socket contact.

Embodiment 2. The socket contact according to Embodiment 1, wherein each beam member comprises the first inwardly raised portion.

Embodiment 3. The socket contact according to Embodiment 1 or 2, further comprising:
a first collar proximal the first end; and/or
a second collar proximal the second end; and
a sidewall portion extending between first collar portion and the second collar portion, wherein the sidewall portion comprises the plurality of slots forming the plurality of beam members.

Embodiment 4. The socket contact according to Embodiment 3 wherein a diameter of an outer surface of each collar is larger than a diameter of outer surface of the sidewall portion.

Embodiment 5. The socket contact according to Embodiment 3 or 4 wherein each end of the beam member is fixed and anchored in the sidewall portion adjacent each collar such that in use when a mating pin enters the socket contact, the beam members are pressed outwards and the contact section remains substantially concentric about a central longitudinal axis of the socket contact.

Embodiment 6. The socket contact according to Embodiment 3, 4 or 5 wherein each collar extends entirely or partially around a circumference of the tubular body.

Embodiment 7. The socket contact according to any of Embodiments 1-6, where there are at least three slots.

Embodiment 8. The socket contact according to any of Embodiments 1-7, wherein each slot generally extends in a direction parallel to a central longitudinal axis of the tubular body.

Embodiment 9. The socket contact according to any of Embodiments 1-8, wherein each slot is aligned adjacent another slot around a periphery of the tubular body.

Embodiment 10. The socket contact according to any of Embodiments 1-9, wherein the slots are angled such that their longitudinal axis is at an angle to a central longitudinal axis of the tubular body.

Embodiment 11. The socket contact according to Embodiment 10, wherein the inwardly raised contact section provides a ridge that includes perpendicular edges to the contact's 25 central longitudinal axis and two angled edges based on the angled edges of a corresponding base member.

Embodiment 12. The socket contact according to any of Embodiments 3 to 11, wherein a section of the body of the socket contact between the first end and the first collar proximal the 30 first end includes one or more indentations around the periphery of the section.

Embodiment 13. The socket contact according to any of Embodiments 3 to 12, wherein a section of the body of the socket contact between the second end and the second collar proximal the second end includes one or more indentations around the periphery of the section.

Embodiment 14. A method of manufacturing a socket contact, comprising:
providing a tubular body having a first end and a second end opposite the first end;
forming a hole through the body along a central longitudinal axis of the body and an opening at the first and/or second end, wherein the hole comprises a portion with at least a first cross section and a portion with at least a second cross section, wherein the first cross section is larger than the second cross section;
forming a plurality of slots to create a plurality of beam members, wherein at least one of the beam members comprises at least a first section that is inwardly raised relative to remaining section of the beam members so as to form a narrower contact section within the socket contact.

Embodiment 15. The method according to Embodiment 14, further comprise adapting the surface of the contact to form a first collar proximal the first end and a second collar proximal the second end, where a sidewall portion extends between first collar and the second collar and the slots are formed in the sidewall portion.

Embodiment 16. The method according to Embodiment 15, wherein a recess is formed in the surface of the tubular body to form the first and second collar.

Embodiment 17. The method according to Embodiment 14, 15, or 16 wherein the forming of the hole through the body comprises forming a through hole having the second cross section before forming a through hole having the second cross section.

Embodiment 18. The method according to Embodiment 14, 15, 16 or 17, wherein the forming of the hole through the body comprises forming a hole with different cross sections and creating a barrel structure, the barrel structure including a first hollow portion of a first diameter, second hollow portion of a second diameter and third hollow portion of a third diameter, wherein the second hollow portion is positioned coaxially between the first and third hollow portions, the second diameter is smaller than the first diameter, and the third diameter is substantially the same as the first diameter, and wherein the narrower contact section is formed in the second hollow portion.

Embodiment 19. The method according to any of Embodiments 12 to 18, wherein the socket contact is formed from a single piece of material.

Embodiment 20. The method according to any of Embodiments 12 to 19, wherein each end of the inwardly raised contact section has a sloped lead-in face.

1. A socket contact (10) comprising:
a tubular body having:
a first end;
a second end opposite the first end, the body having an opening (11, 12) at the first and/or second end;
a plurality of slots (13a, 13b, 13c) forming a plurality of beam members (14a, 14b, 14c), wherein at least one of the beam members comprises at least a first section (15a, 15b, 15c) that is inwardly raised relative to the remaining section of the beam members so as to form a narrower contact section within the socket contact, wherein the inwardly raised contact section provides a ridge that includes perpendicular edges (17a, 17b) to the contact's central longitudinal axis (X) and two angled edges (18a,18b) based on the angled edges of a corresponding base member;
a first collar (19) proximal the first end;
a second collar (20) proximal the second end; and
a sidewall portion (21) extending between first collar portion and the second collar portion, wherein the sidewall portion comprises the plurality of slots forming the plurality of beam members, wherein each end of the beam member is fixed and anchored in the sidewall portion adjacent each collar such that in use when a mating pin enters the socket contact, the beam members are pressed outwards and the contact section remains substantially concentric about a central longitudinal axis of the socket contact.

2. The socket contact according to claim 1, wherein each beam member comprises the first inwardly raised portion.

3. The socket contact according to claim 1, wherein a diameter (d1) of an outer surface of each collar is larger than a diameter (d2) of outer surface of the sidewall portion.

4. The socket contact according to claim 1, wherein each collar extends entirely or partially around a circumference of the tubular body.

5. The socket contact according to claim 1, where there are at least three slots.

6. The socket contact according to claim 1, wherein each slot generally extends in a direction parallel to a central longitudinal axis of the tubular body.

7. The socket contact according to claim 1, wherein each slot is aligned adjacent another slot around a periphery of the tubular body.

8. The socket contact according to claim 1, wherein the slots are angled such that their longitudinal axis is at an angle to a central longitudinal axis of the tubular body.

9. (canceled)

10. The socket contact according to claim 1, wherein a section of the body of the socket contact between the first end and the first collar proximal the first end includes one or more indentations (26) around the periphery of the section.

11. The socket contact according to claim 1, wherein a section of the body of the socket contact between the second end and the second collar proximal the second end includes one or more indentations (26) around the periphery of the section.

12. A method of manufacturing a socket contact, comprising:
providing a tubular body having a first end and a second end opposite the first end;
forming a hole through the body along a central longitudinal axis (X) of the body and an opening (11, 12) at the first and/or second end, wherein the hole comprises a portion with at least a first cross section and a portion with at least a second cross section, wherein the first cross section is larger than the second cross section;
forming a plurality of slots (13a, 13b, 13c) to create a plurality of beam members, (14a, 14b, 14c), wherein at least one of the beam members comprises at least a first section (15a, 15b, 15c) that is inwardly raised relative to remaining section of the beam members so as to form a narrower contact section within the socket contact, wherein the inwardly raised contact section provides a ridge that includes perpendicular edges (17a, 17b) to the contact's central longitudinal axis (X) and two angled edges (18a,18b) based on the angled edges of a corresponding base member;
further comprising adapting the surface of the contact to form a first collar (19) proximal the first end and a second collar (20), proximal the second end, where a sidewall portion (21) extends between first collar and the second collar and the slots are formed in the sidewall portion, wherein each end of the beam member is fixed and anchored in the sidewall portion adjacent each collar such that in use when a mating pin enters the socket contact, the beam members are pressed outwards and the contact section remains substantially concentric about a central longitudinal axis of the socket contact.

13. The method according to claim 12, wherein a recess is formed in the surface of the tubular body to form the first and second collar.

14. The method according to claim 12, wherein the forming of the hole through the body comprises forming a through hole having the second cross section before forming a through hole having the first cross section.

15. The method according to claim 12, wherein the forming of the hole through the body comprises forming a hole with different cross sections and creating a barrel structure, the barrel structure including a first hollow portion of a first diameter (d3), second hollow portion of a second diameter (d4) and third hollow portion of a third diameter (d5), wherein the second hollow portion is positioned coaxially between the first and third hollow portions, the second diameter is smaller than the first diameter, and the third diameter is substantially the same as the first diameter, and wherein the narrower contact section is formed in the second hollow portion.

16. The method according to claim 12, wherein the socket contact is formed from a single piece of material.

17. The method according to claim 12, wherein each end of the inwardly raised contact section has a sloped lead-in face (64).
